(19) United States
(12) Patent Application Publication
(10) Pub. No.: US 2022/0055692 A1
(43) Pub. Date: Feb. 24, 2022

(54) MULTILAYER UNIFORM DECELERATION UNIT

(71) Applicant: Tesseract Structural Innovations, Inc., Fayetteville, AR (US)

(72) Inventor: Henry L. Renegar, Fayetteville, AR (US)

(73) Assignee: Tesseract Structural Innovations, Inc., Fayetteville, AR (US)

(21) Appl. No.: 17/392,190

(22) Filed: Aug. 2, 2021

Related U.S. Application Data
(63) Continuation of application No. PCT/US2021/020126, filed on Feb. 27, 2021.
(60) Provisional application No. 62/982,740, filed on Feb. 27, 2020.

(51) Int. Cl. B62D 21/15; B62D 25/18; B62D 29/00

(52) U.S. Cl. CPC B62D 21/152; B62D 29/001; B62D 25/18

(57) ABSTRACT

Embodiments disclosed herein include a safety device with a body having a first end, a second opposite end, and a plurality of stacked crash pad layers. A stiffness of the body is arranged to increase in a direction from the first end of the body towards the second end of the body. In some embodiments, the stiffness of the body increases in a fore-aft direction when the safe device is installed in art automobile.

### RELATED APPLICATIONS

This application is a continuation of and claims priority under 35 U.S.C. § 120 to International Application Number PCT/US2021/020126, filed Feb. 27, 2021, which claims the benefit under 35 U.S.C. § 119(e) to U.S. Provisional Application Ser. No. 62/982,740, entitled “MULTILAYER UNIFORM DECELERATION UNIT” and filed Feb. 27, 2020. The entire contents of each of these applications are incorporated herein by reference in their entireties.

### FIELD

The disclosed embodiments relate generally to automobiles and more particularly to safety systems arranged to improve the performance of an automobile in frontal, rear, and side crashes.

### BACKGROUND

Automobile accidents are an unfortunate reality in the world today. Every year, tens of thousands of accidents occur in the United States alone. These accidents can cause, at a minimum, a financial strain on the automobile owner and insurance company, and, in worst case scenarios, can result in the fatality of the driver and/or other occupants in the vehicle. In recent decades, the automotive industry has seen great advances in safety with innovations such as frontal air bags, side curtain airbags, electronic crash avoidance systems, and structural crumple zones, to name a few. Still, with the safety innovations we have today, there is a demand to further improve the safety of automobiles.

### SUMMARY

According to one embodiment, a safety device for absorbing crash energy includes a body having a first end, a second opposite end, and a plurality of stacked crash pad layers. Each of the plurality of crash pad layers includes an outer skin. A stiffness of the body increases in a direction from the first end of the body towards the second end of the body.

According to another embodiment, a safety device for absorbing crash energy includes a body having a first end, a second opposite end, and a plurality of stacked crash pad layers. Each of the plurality of crash pad layers includes an outer skin. The plurality of crash pad layers includes a first crash pad layer and a second crash pad layer. A thickness of the outer skin of the first crash pad layer is greater than a thickness of an outer skin of the second crash pad layer.

According to another embodiment, a safety device for absorbing crash energy includes a body having a first end, a second opposite end, and a plurality of stacked crash pad layers. Each of the plurality of crash pad layers includes an outer skin. The plurality of crash pad layers includes a first crash pad layer and a second crash pad layer. The first crash pad layer includes a first inner skin and the second crash pad layer includes a second inner skin. A cross-sectional area of the first inner skin is greater than the cross-sectional area of the second inner skin. A stiffness of the first crash pad layer is different than a stiffness of the second crash pad layer.

It should be appreciated that the foregoing concepts, and additional concepts discussed below, may be arranged in any suitable combination, as the present disclosure is not limited in this respect.

The foregoing and other aspects, embodiments, and features of the present teachings can be more fully understood from the following description in conjunction with the accompanying drawings.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is the inventor's earlier-described Uniform Deceleration Unit (“UDU”) installed in a wheel well of an automobile;

FIG. 2 is a multilayered UDU according to embodiments of the present disclosure installed in an automobile;

FIG. 3 is a perspective view of a multilayered UDU according to some embodiments;

FIG. 4 is a cross-sectional view of the multilayered UDU of FIG. 3 taken along line A-A;

FIG. 5 is a representation of a UDU in an automobile crash;

FIG. 6 is a force vs. displacement curve for a single layer UDU crush;

FIG. 7 is a force vs. displacement curve for a two layer UDU crush;

FIGS. 8 and 9 are top perspective views of illustrative crash pad layers of a UDU according to some embodiments;

FIG. 10 is a top perspective view of a crash pad layer according to some embodiments;

FIGS. 11A-11C are top perspective views of crash pad layers according to some embodiments;

FIG. 12 is a side perspective view of a multilayered UDU according to some embodiments;

FIG. 13 is a perspective view of a multilayered UDU according to some embodiments;

FIGS. 14-17 are top perspective views of crash pad layers according to some embodiments;

FIG. 18 is an enlarged perspective view of a portion of a multilayered UDU according to some embodiments;

FIG. 19 is a schematic side view of crash pad layers of a multilayered UDU according to another embodiment;

FIG. 20 is a schematic side view of a crash pad layer of a multilayered UDU according to some embodiments;

FIG. 21 is the multilayered UDU of FIG. 20;

FIG. 22A is a perspective view of a crash pad layer according to some embodiments, with FIG. 22B being a perspective view of a cellular material insertable into the crash pad layer of FIG. 22A;

FIG. 23A is a perspective view of a crash pad layer according to some embodiments, with FIG. 23B being a perspective view of a cellular material insertable into the crash pad layer of FIG. 23A;

FIG. 24A is a perspective view of a crash pad layer according to some embodiments, with FIG. 24B being a perspective view of a cellular material insertable into the crash pad layer of FIG. 24A;

FIG. 25A is a perspective view of a crash pad layer according to some embodiments, with FIG. 25B being a perspective view of a cellular material insertable into the crash pad layer of FIG. 25A;

FIGS. 26-30 are top perspective views of crash pad layers according to some embodiments;

FIG. 31 shows a two layered UDU, with an outer skin structure shown removed from a first (upper) layer;

FIGS. 32-38 are top views of crash pad layers according to some embodiments;

FIG. 39 is a force vs. displacement curve for a multilayered UDU with four layers;

FIGS. 40-43 are perspective views of multilayered UDUs according to some embodiments;

FIGS. 44 and 45 are side views of multilayered UDUs according to some embodiments; and

FIG. 46 is a perspective view of a multilayered UDU according to some embodiments.

### DETAILED DESCRIPTION

Automobile accidents are an unfortunate reality in the world today. Although the automotive industry has seen great advances in safety in the past four decades with innovations such as frontal air bags, side curtain airbags, lane departure systems, electronic crash avoidance systems, and structural crumple zones, to name a few, there are still accidents and still a demand to further improve the safety of automobiles.

The most severe vehicle crash type, in terms of the number of lives lost each year, is the frontal small overlap (SOL). In order to simulate the SOL crash, the Insurance Institute has developed the Narrow Offset (Small Overlap) Front Impact Test, which was developed to simulate the effects of a vehicle striking a rigid object such as a utility pole or a tree. The test also simulates the situation where two vehicles collide head-on with an offset between the centerlines of the vehicles.

In an on-center, head-on collision, the vehicle would strike a rigid object in the center of the front bumper and the entire crumple zone of the vehicle front end would absorb the crash energy. In such instances, the energy absorbing action of the front crumple zone, combined with the air bags and seat belts, may give the vehicle driver and front passenger a good chance of surviving the crash and walking away with only minor injuries. However, the Small Overlap front impact drives crash energy through the outer 25% of the front of the vehicle.

Typically, automobiles do not have significant structural components in the region receiving the impact in small overlap frontal crashes. As such, the majority of the crash energy in the test may pass through the outer left front side (e.g., the driver's side) of the vehicle, through a region where there is little structure to absorb the energy. If unchecked, this crash energy can result in very high forces that can drive the wheel and other components through the wheel well and the lower dash panel wall and into the driver's foot and leg space. This intrusion of vehicle mass into the driver's space inside the vehicle can result in serious injuries to the lower body areas of the driver, such as from the waist to the toes. In some instances, if the air bags fail to restrain the driver properly, the driver can suffer a severe head injury that could result in death.

Traditionally, automakers have used several strategies to improve their vehicles' performance in both simulated (e.g., to pass the IIHS Small Overlap Impact Test) and real world accidents. These strategies may include: (1) Adding structure (i.e., mass) to the front corners of the vehicle between the front bumper and the panel at the aft side of the wheel well. (2) Adding early engagement structures that can change kinematic motion of the crash, such as by creating imbalanced forces that may make the vehicle spin away from the object being impacted (e.g., the crash test barrier in the SOL test). In such instances, by making the vehicle spin away from the crash test barrier, energy may be absorbed and the wheel may not become the primary load path. (3) Adding occupant compartment reinforcement to help prevent intrusion into the driver and passenger spaces. Such reinforcements may establish alternate load paths for crash force. (4) Designing structural members, such as the lower control arm and the wheel, to fracture under a given load after a prescribed deflection so as to absorb a portion of the crash energy and minimize forces on the lower dash panel and prevent intrusion into the driver space. Such a strategy also may be used as a way to cut the load path and create imbalanced forces that will spin the car away from the crash barrier. Such known strategies, however, do not provide a satisfactory solution in all aspects.

The inventor has recognized the advantages of a Uniform Deceleration Unit (“UDU”) arranged to absorb crash energy. Examples of different configurations for UDUs are described in International Application No. PCT/US2015/062366, filed Nov. 24, 2015 and entitled “Uniform Deceleration Unit,” and in U.S. application Ser. No. 16/386,071, filed Apr. 16, 2019 and entitled “Uniform Deceleration Unit,” each of which is incorporated by reference herein in its entirety.

The inventor has recognized that advantages may be realized by providing a UDU that includes one or more individual layers, such as crash pad layers, that are stackable (e.g., like layers on a cake). For example, in some embodiments, a multilayered UDU may be systematically designed to absorb a specific amount of energy appropriate to the mass and shape of a vehicle. In some embodiments, stiffness of each layer may be varied to control the shape of the crash force vs. displacement (“F-D”) curve and to control the amount of energy absorbed. In some embodiments, the multilayered UDU may be arranged to crush in a predictable and sequential fashion. In some embodiments, the multilayered UDU may generate a smooth F-D curve without force spikes, which may eliminate material fractures that could lead to structural failure.

In some embodiments, the crash pad layers may be arranged to create a stiffness gradient across a crash pad, with the crash pad being formed of one or more crash pad layers, and/or across the UDU. In some embodiments, this gradient may improve or otherwise control the energy absorption of the crash pad and/or UDU, such that crash load may be more evenly distributed along an individual crash pad layer. In some embodiments, the stiffness of the multilayered UDU is arranged to increase in the fore-aft direction of the automobile when the UDU is installed in the automobile. In some embodiments, a stiffness of each crash pad, which may include the one or more crash pad layers, also may increase in the fore-aft direction of the automobile when the UDU is installed.

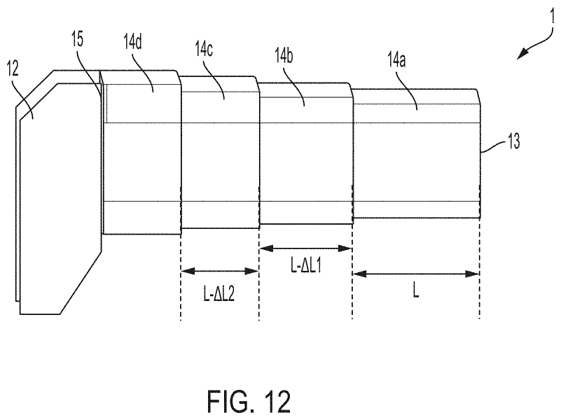

In some embodiments, the stiffness of the various layers of the crash pad and/or of the UDU may be varied by varying a length of each layer in the crash pad and/or the UDU. In such embodiments the length may be calculated as a distance between a bottom and a top of the crash pad layer (see, e.g., FIG. 12). Stiffness also may be varied by varying the cross-sectional area of each layer in the crash pad and/or UDU. A wall thickness of an outer skin structure of each layer also may be varied from layer to layer to vary the stiffness gradient. Stiffness also may be varied by introducing features to control the axial deformation of each crash pad layer. For example, in some embodiments, the outer skin structure of one or more layers may include regions of weakness, such as notches. In other embodiments, the outer skin structure may include one or more local stiffeners, such as regions of the outer wall structure with a wall thickness that is larger than a wall thickness in other regions. In some embodiments, the outer skin structure may include both weakened regions and local stiffeners. In still other embodiments, stiffness may be varied by varying the amount of foam in each layer. Stiffness also may be varied by including one or more inner skin structures, also referred to herein as inner stiffeners or inner skins. For example, the layers may have one or more tubular structures, or other suitably shaped structures, inside the outer skin layer to absorb energy. In some embodiments, stiffness may be varied by varying a cross-sectional area of one or more of the inner skin structures. In some embodiments, the inner stiffeners are attached to the outer skin.

In some embodiments, the multilayered UDU may be an integral component of the vehicle frame structure. For example, in some embodiments, the multilayered UDU may be shaped to fit into the wheel well shadow space of virtually any vehicle. In such embodiments, each crash pad layer of the multilayered UDU may have a unique structural design as required to produce a sequential crush and to fit the available vehicle wheel well shape. The multilayered UDU also may be arranged to fit the available space of another suitable portion of the vehicle. In some embodiments, the multilayered UDU may be arranged to retrofit into the wheel well space of an automobile, or another suitable portion of the vehicle. In some embodiments, the multilayer UDU may be designed to absorb from between about 5% to 100% of a vehicles SOL crash energy.

In some embodiments, specific layers of the multilayer UDU may be fabricated from different materials to optimize material strength, ductility, and fracture toughness. In some embodiments, this may be used to optimize UDU mass and energy absorption. In some embodiments, the UDU may be formed of a high tensile strength material, such as a high tensile strength metal. In some embodiments, the outer skin may have high ductility, high strength, and a relatively low modulus. In such embodiments, the outer skin may be formed via casting, forging, or another metal forming technique. In some embodiments, the high tensile strength material may surround a cellular material, such as a metallic foam. As will be described, the cellular material may be inserted into one or more of the inner skin structures in some embodiments.

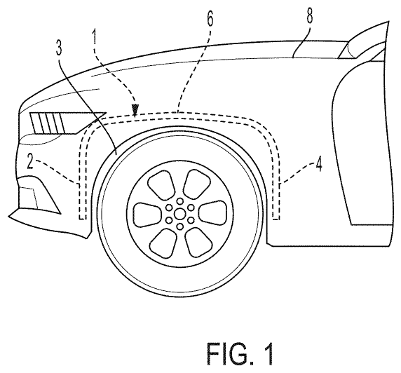

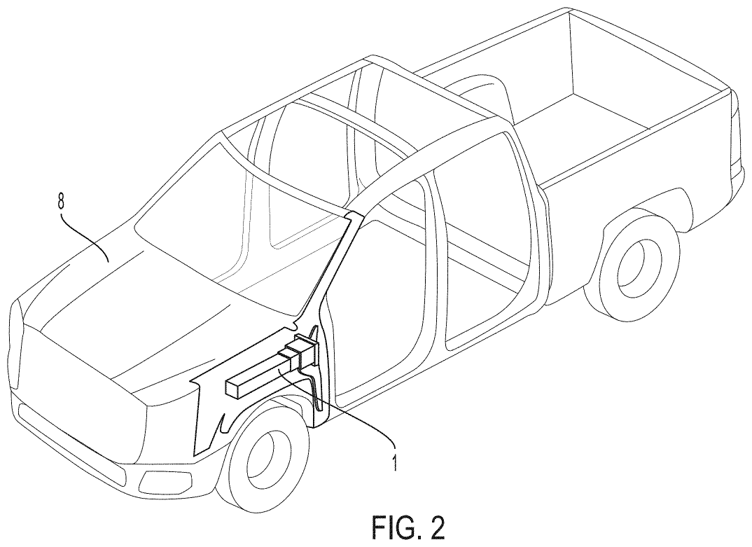

Turning now to the figures, FIG. 1 shows the inventor's earlier-described UDU 1 that has been installed in a wheel well 3 of an automobile 8. As will be appreciated, UDUs may be installed in a front wheel well, a rear wheel well, or in both front and rear wheel wells. The UDU also may be installed in other suitable portions of the automobile, such as in a side door of the automobile. As shown in FIG. 1, the UDU may include a generally U-shaped energy absorbing member having first and second crash pads 2, 4 and a connection beam 6 disposed between and connecting the first and second crash pads. In some embodiments, the first crash pad may include a forward crash pad while the second crash pad includes an aft crash pad. In some embodiments, the UDU may include multiple forward crash pads 2 and/or multiple aft crash pads 4 that are joined to the connection beam 6. As shown in FIG. 1, the UDU may be used with a passenger car in some embodiments. As will be appreciated, UDUs may be used with all types of automobiles, including but not limited to cars, trucks, sport utility vehicles, vans, busses, motorcycles, and crossover vehicles. FIG. 2 shows a multilayered UDU 1 according to embodiments of the present disclosure installed in the wheel well of another automobile, a truck. As described herein, the UDU may be sized to fit within the available space in the wheel well of the truck, or of another suitable automobile. In this regard, each layer of the UDU may be configured such that the UDU extends over and/or around the wheel of the automobile for energy absorption. As shown in this FIG. 2, the UDU need not have a U-shape in some embodiments, although it will be appreciated that the UDU may have a U-shape in some embodiments.

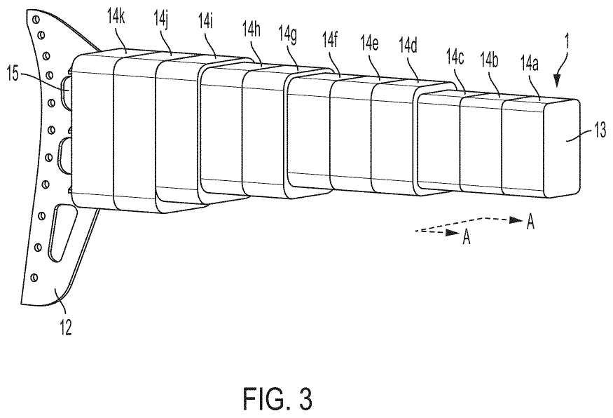

FIG. 3 shows the multilayered UDU according to some embodiments of the present disclosure. As shown in this view, the UDU includes a body having one or more of stacked crash pad layers. In some embodiments, the body includes a first end 13 and a second, opposite end 15. In some embodiments, the first end may be a fore end and the second end may be an aft end of the UDU body when the UDU is installed in an automobile. In some embodiments, the stacked crash pad layers may extend from the first end to the second end. As shown in FIG. 3, in some embodiments, the UDU may include 11 crash pad layers 14a-14k, although the crash pad may include other suitable numbers of crash pads layers. For example, the UDU may have at least one, two, three, four, five, six, seven, eight, nine, ten, eleven, twelve, thirteen, fourteen, fifteen, seventeen, twenty, twenty-five, or any other suitable numbers of crash pad layers as the present disclosure is not so limited. As will be appreciated, in some embodiments, one or more of the crash pad layers may form the first crash pad, the second crash pad, and/or a connecting beam of the UDU. In some embodiments, the UDU may include a bracket 12 which may be used to attach the UDU to a desired region of the vehicle. As will be appreciated, the UDU may be attached to the automobile in other suitable manners (e.g., via one or more fasteners).

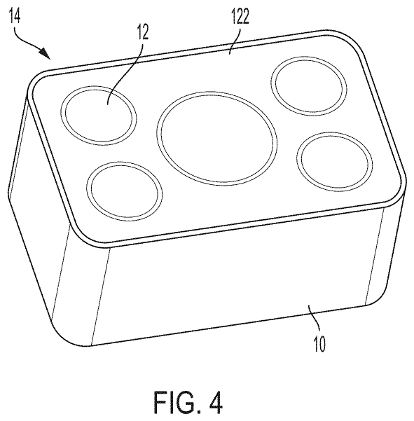

FIG. 4 depicts a cross-section of an illustrative crash pad layer of the UDU of FIG. 3, taken along line A-A. As shown in this figure, the crash pad layer may include an outer skin 10, which may span the periphery of the crash pad layer. The crash pad layer also may include one or more inner skin structures 12 (e.g., inner stiffeners), which may be positioned inside of the outer skin structure 10. As shown in FIG. 4, the inner skin structures may include tubular members, such as the five tubular members shown in this figure. In some embodiments, each of the tubular members may include the same cross-sectional shape, such as the circular cross-sectional shape shown in FIG. 4. The tubular members also may have different shapes in other embodiments. In some embodiments, the inner skin structures may have the same cross-sectional size, although the size of the tubular members may vary from inner skin structure to inner skin structure. As described herein, the structure of the inner and outer skins 10, 12 may vary in other embodiments.

In some embodiments, the crash pad layer may include a cellular material, such as a metallic foam 122 or another suitable material capable of energy absorption. In some embodiments, the cellular material may be positioned in and/or around each of the inner skin structures. The cellular material also may be positioned only around the inner skin structures, only inside the inner skin structures, or combinations thereof. It should be appreciated that in some embodiments, the inner and outer skin structures may be substantially made of the same material, whereas in other embodiments, the inner and outer skin structures may be made of different materials.

In some embodiments, each crash pad layer may be designed to absorb energy and generate progressively and incrementally higher forces as the UDU gets crushed. For example, in some embodiments, as each layer crushes, the outer structure of that layer may reach a local maximum force and then begin to deform to a point at which the load begins to decrease. At that point, the cellular material (e.g., metallic foam material), or other similar energy absorbing material filling the inner and/or outer skin structures, may crush to a condition such that the foam will crush at a constant load.

In some embodiments, the UDU may be arranged to have a stiffness gradient that generally increase in the fore-aft direction when the UDU is installed in the automobile. In such embodiments, the stiffness of each subsequent layer of the multi-layer UDU device may increase slightly from forward to aft in the vehicle. In such embodiments, as the device crushes, the initial layer of outer skin structure may reach a peak force and begin to plastically deform before the subsequent layer reaches its peak force. The subsequent layer may begin deforming prior to the first layer reaching maximum force. For example, all of the stacked layers may be deforming simultaneously in some embodiments. In some embodiments, using the metallic foam's or other similar material's unique ability to crush at a relatively constant force, for a specific proportion of the initial layer thickness, the force achieved by the outer skin structure of each layer may be effectively held constant through a predetermined range of the layer's initial thickness.

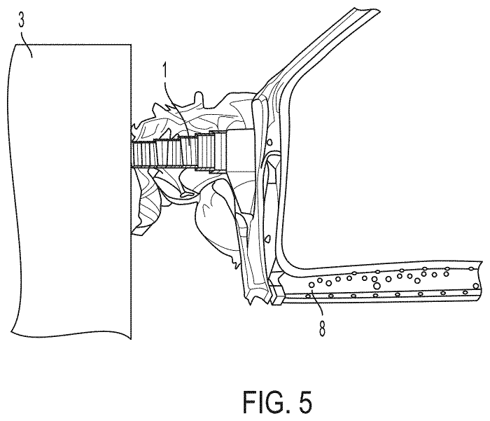

As shown in FIG. 5, when the vehicle 8 crashes (e.g. into an obstruction 3), each crash pad layer of the UDU may exhibit a different behavior as a result of the features and properties described herein. For example, in some embodiments, the fore-most crash pad layers may buckle or otherwise collapse, while some of the aft-most crash pad layers may remain structurally intact. In some embodiments, when the automobile hits the obstruction, the UDU is arranged to deform plastically to absorb crash energy.

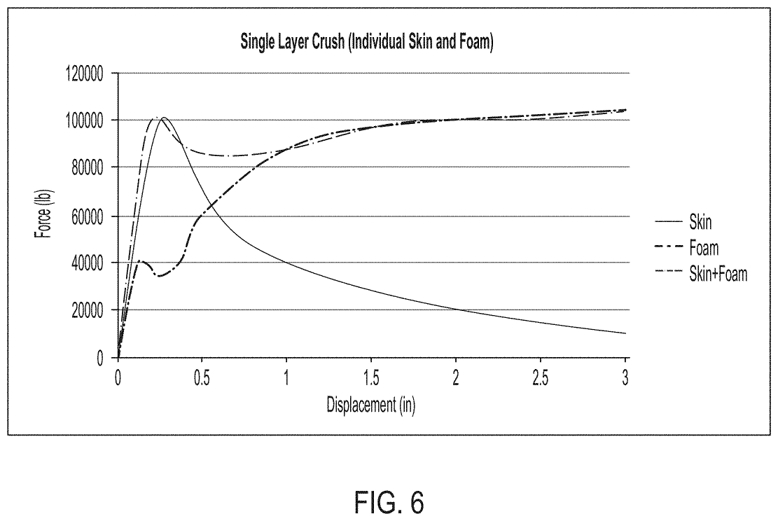

In some embodiments, the outer skin structure may be designed to begin plastic deformation at a specific load (see, e.g., FIG. 6). In such embodiments, the foam material may then be designed to reach its force plateau for each layer at the same force at which the outer skin structure begins to buckle. As also shown in this view, an individual layer with both an outer skin and foam may begin to plastically deform at a specific load (e.g., via the outer skin) and then hold that load via the foam.

In some embodiments, the thickness of each layer of the UDU may be determined via one or more criteria. For example, the thickness may be controlled by the desired peak force of the outer skin structure, the length of the foam's constant force plateau, and/or the relative stiffness of the subsequent layer.

In some embodiments, each subsequent layer of the stacked UDU structure may be designed such that the layers crush sequentially and maintain a relatively constant force, or a slowly increasing or decreasing force, for the duration of the crushing event.

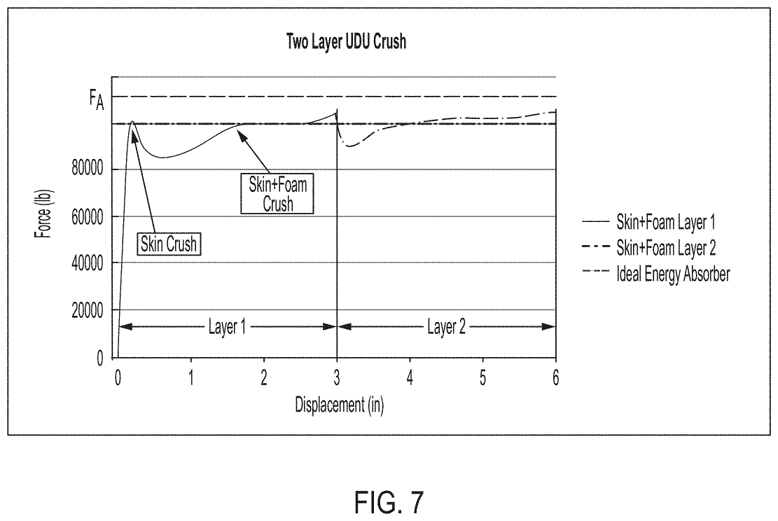

FIG. 7 shows a representative force vs. displacement (“F-D”) curve for a sequential crush of a multilayer UDU structure. As shown in this figure, the behavior of the UDU structure may approach very closely to the straight, red horizontal line. This line indicates the ideal energy absorber for the design space defined in the graph. As also shown in FIG. 4, the peak crush force for each UDU layer may be less than FA, indicated by the dashed purple line, where F_{A} is the allowable load prior to collapse for the vehicle structural members in the SOL load path. These structural members may include the hinge pillar, A-pillar, A-pillar reinforcement, rocker, and/or side sill. In some embodiments, by limiting the crush force to a magnitude less than FA, the UDU may absorb the energy of the SOL crash while preventing the collapse of key structural members that support the vehicle occupant compartment.

As will be appreciated, while FIG. 7 shows a two-layered UDU structure, the concept may be practically extended to any number of layers as would be dictated by the physical size and mass of the vehicle for which the structure was being designed.

As shown in FIG. 7, the multilayered UDU may approach an ideal energy absorber for a given design space through a uniform sequential crush of subsequent layers of the structure. As described herein, there are a number of ways for a structure to achieve a sequential crush such that subsequent layers of the segmented UDU will compress in sequential order.

As described herein, the performance of each individual crash pad layer in response to a crash may be tuned by configuring the stiffness of each individual layer. In some embodiments, the stiffness adjustment may correspond to an adjustment of the cross-sectional area of the individual crash pad layer, which may correspond to the absorbed load during a crash. For example, the cross-sectional area of the crash pad layer may be increased (or decreased) by increasing (or decreasing) the overall footprint of each crash pad layer. In some embodiments, the footprint of a first crash pad layer may be smaller than a footprint of a second crash pad layer. In some embodiments, adjacent crash pad layers may have the same footprint or may have different footprints. In such embodiments, the first and second crash pads may be adjacent, although it will be appreciated that the first and second crash pads also may be spaced apart in the UDU.

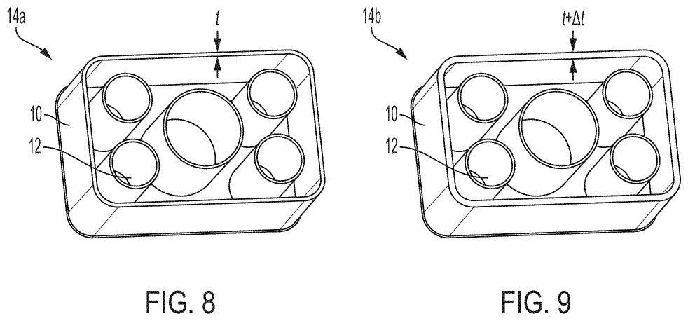

In some embodiments, the cross-sectional area of an individual crash pad can be adjusted by varying a thickness t of the outer skin structure 10. As shown in FIG. 8, for example, a first crash pad layer 14a may include an outer skin structure 10 with a thickness t (e.g., a wall thickness) while a second crash pad layer 14b, shown in FIG. 9, may have a thickness t+Δt. In such embodiments, the second crash pad layer 14b may have a thicker outer skin structure 10 than the first crash pad layer 14A. In some embodiments, the outer skin structure thickness t may be increased by Δt in a direction away from an outer surface of the outer skin structure (and away from the inner skin structures 12). Accordingly, the cross-sectional area (e.g., footprint) of the crash pad layer may be increased as a result of an increase in the outer skin structure thickness t by Δt. In some embodiments, the thickness t of the crash pad layer may be at least 0.02, 0.05, 0.1, 0.2, 0.3, 0.4, 0.5, 0.6, 0.7, 0.8, 0.9, 1, 1.1, 1.2, 1.3, 1.4, 1.5, 2, 2.5, 3, 3.5, 4, 4.5, 5 inches, or any other suitable thickness t, as the present disclosure is not so limited.

In some embodiments, the change in thickness Δt between crash pad layers may not change the overall cross-sectional area (e.g., footprint) of the crash pad layer. For example, in some embodiments, the thickness t of the crash pad layer may be increased in a direction towards the inner skin structure(s) 12. Accordingly, the cross-sectional area of the outer skin structure may be increased (or otherwise changed), while the cross-sectional area of the crash pad layer remains substantially unchanged. In such embodiments, changing the outer skin structure thickness may still change the stiffness of the crash pad layer. As will be appreciated, in some embodiments, extension of the outer skin structure (e.g., by Δt) towards the inner skin structures 12 may reduce the space available for the inner skin structures and/or metallic foam material within the outer skin structure.

It should be appreciated that the thickness t may increase in a combination of directions. For example, the thickness t may increase partially towards the inner skin structures 12 and partially away from the inner skin structures 12. In some embodiments, the thickness t may increase substantially equally towards and away from the inner skin structures 12. In such embodiments, the cross-sectional area (e.g., footprint) of the crash pad layer may be increased while the area inside the outer skin structure (e.g., for the inner skin structures or foam) may be decreased.

The thickness difference Δt between crash pad layers (e.g., 14a, 14b) may be any suitable value to achieve the desired stiffness change in the layers. In embodiments of the multilayered UDU with more than two crash pad layers, the difference between outer skin structures may continue to increase by Δt. In such embodiments, the difference between outer skin structures may vary from Δt, to 2Δt, to 3Δt, . . . to nΔt depending upon the number of layers. In such embodiments, the variation of the thickness between crash pad layers may be linear. For example, each subsequent crash pad layer may have an increased outer skin structure thickness of 10%. It should be appreciated that the thickness difference Δt between adjacent or neighboring crash pad layers may be at least 1%, 2%, 3%, 4%, 5%, 7%, 10%, 12%, 15%, 17%, 20%, 25%, 30%, 35%, 40%, 45%, 50%, 60%, 65%, 70%, 75%, 80%, 85%, 90%, 95%, 100%, 110%, 120%, 150%, 175%, 200%, 250%, 300%, 350%, 400%, 450%, 500%, or any other suitable thickness difference. In other embodiments, the variation of the thickness between crash pad layers may be non-linear. In still other embodiments, the variation in thickness between crash pad layers may be monotonic or non-monotonic, as the present disclosure is not so limited. Although described with respect to increasing the thickness of the outer skin layer, it will be appreciated that the thickness of the outer skin structure may be decreased in various increments.

In some embodiments, as shown in FIGS. 8 and 9, the thickness of the outer skin structure may be uniform along a periphery of the crash pad. In some embodiments, a uniform thickness t along the periphery of the crash pad may improve manufacturing efficiency for some embodiments of the crash pad. In other embodiments, the thickness of the outer skin structure may be non-uniform along the periphery of the crash pad 14. For example, the outer skin structure may be thicker along portions of the crash pad layer which may be positioned to receive a greater load during a crash. The thickness of the outer skin structure also may be reduced in other portions of the crash pad layer to create areas of weakness. It should be appreciated that the thickness of the outer skin may follow any suitable variation along the periphery of the crash pad 14, including, but not limited to constant, varying monotonically, varying non-monotonically, or any other suitable variation.

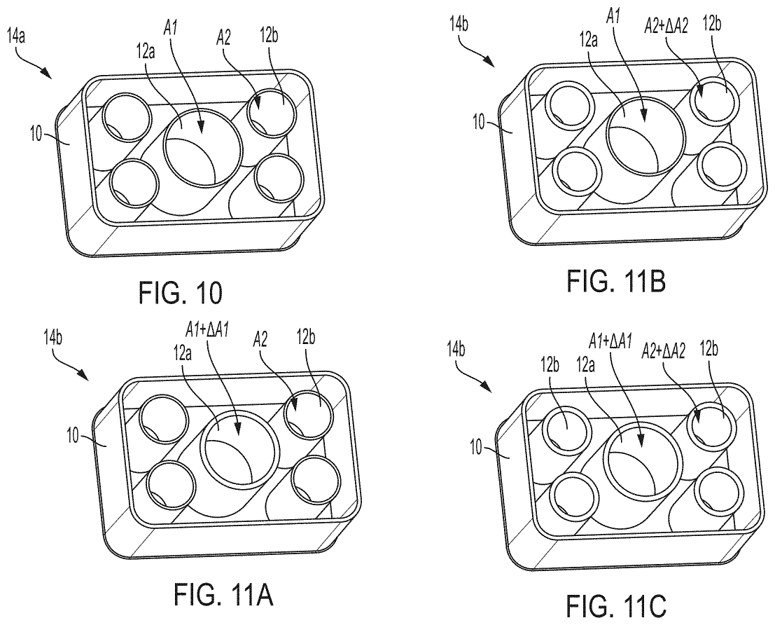

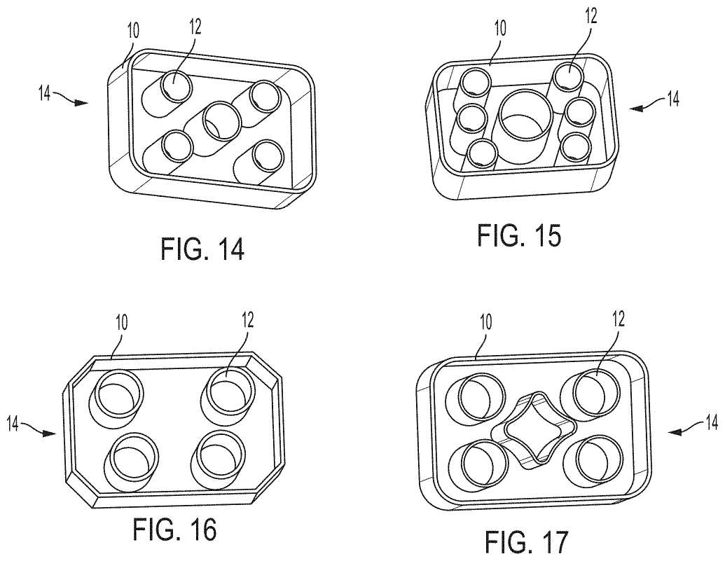

In some embodiments, stiffness of the UDU may be varied by varying the cross-sectional area of one or more of the inner skin structures 12 of the crash pad layers. For example, as shown in FIG. 10, in some embodiments, crash pad layers 14a and 14b may each have five inner skin structures. In such an example, the inner skin structures may include a larger inner skin structure 12a surrounded by four smaller inner skin structures 12b. As shown in FIGS. 10-11C, each of the inner skin structures may include a hollow tubular structure. In some embodiments, as shown in these views, the tubular structures may be substantially circular in cross-sectional shape. As will be appreciated, the inner skin structures may have other suitable cross-sectional shapes in other embodiments. For example, the skin structures may include square, triangular, rectangular, oval, other polygonal, or other suitable cross-sectional shape (see, e.g., FIGS. 14-17). Each crash pad may have inner skin structures that are all the same cross-sectional shape, although the cross-sectional shape of the skin structures may vary from structure to structure (or from a subset of the inner skin structures to another subset of the inner skin structures). The inner skin structures also may be the same size, although the size may vary from skin structure to skin structures.

As shown in FIG. 10A, in a first crash pad layer 14a, the cross-sectional area of the first inner skin 12a may be A1 while the cross-sectional area of the second inner skin 12b may be A2. In such embodiments, in a second crash pad layer 14b, the cross-sectional area of the first inner skin 12a may be changed from A1 to A1+ΔA1 (see FIG. 11A) and/or the cross-sectional area of the second inner skins (or only some of the second inner skins) may increase from A2 to A2+ΔA2 (see FIG. 11B). While changes in the cross-sectional area of only some of the inner skins are shown in FIGS. 11A and 11B, in other embodiments, all of the inner skins may experience a change in the cross-sectional area (see FIG. 11C). In such embodiments, the change in cross sectional area (ΔA1, ΔA2) may be the same, although it may vary from inner skin to inner skin.

In some embodiments, changing the cross-sectional area with respect to the crush axis may change the axial stiffness. For example, increasing the cross-sectional area may improve the stiffness of the crash pad layer 14a, 14b in some embodiments.

In some embodiments, increasing the cross-sectional area of one of the inner skins may be achieved by increasing the footprint of the inner skin. In some embodiments, a thickness of the inner skin may remain the same while the overall cross-sectional area of the inner skin is changing. In such embodiments, the area inside the inner skins may increase when the footprint of the inner skin increase. In other embodiments, increasing the cross-sectional area of one of the inner skins may be achieved by increasing a wall thickness of the inner skin. In such embodiments, the area inside the inner may not change. For example, a thickness of the inner skin may increase only in a direction towards the outer skin, with the area inside the inner skin remaining substantially unchanged. In still other embodiments, a thickness of the inner skin also may increase in a direction towards a center of the inner skin and away from the outer skin. In such embodiments, the area inside the inner skin may decrease with a change in the cross-sectional area. As will be appreciated, the change to each inner skin may be the same or the change may vary from skin to skin.

Although only the outer skin structure is described as being varied in some embodiments, and only the inner skin structures are described as being varied in other embodiments, in some embodiments, the cross-sectional area of both the outer and inner skin structures may be varied, or a combination of portions of the outer and/or inner skin structures may be varied.

In other embodiments, as shown in FIG. 12, stiffness of a crash pad layer may be adjusted by adjusting the length (measured along the crush axis) of the crash pad layer. In some embodiments, a reduction in the length may increase the stiffness of the crash pad layer by reducing the buckling load and/or bending moment. In other embodiments, a reduction in length may not increase the stiffness of the crash pad layer. In an exemplary embodiment, as shown in FIG. 12, the UDU may include three crash pad layers 14a-14c. The first layer 14a may have a first length L, the second layer 14b may have a second length L-ΔL1, and the third layer 14C may have a third length L-ΔL2. It should be appreciated that while a decrease in length is shown for the crash pad layers of FIG. 12 (e.g., from the first end 13 of the body to towards the second end of the body), the change in length of each crash pad layer may increase in other suitable manners in other embodiments. The length of the crash pads also may increase and thereafter decrease in a direction from the first end of the body toward the second end of the body. In still other embodiments, one or more crash pads may have the same length in the UDU.

In some embodiments, the length L of any crash pad layer 14 may be between 0.5 and 12 inches. The change in the length L of each crash pad layer 14, for example to L-ΔL2 or L-ΔL1, may be any suitable value. It should be appreciated that the differences in thickness t for the outer skin structure 10 describes previously may also be used in relation to the differences in length between crash pad layers. While a monotonically changing length is shown in FIG. 12 (i.e., length of layer 14a is greater than the length of layer 14b, which is greater than length of layer 14C), it should be appreciated that any suitable variation in length between crash pad layers may be used.

In some embodiments, the overall stiffness of the layers may be varied via combinations of changes in the cross-sectional area of the individual layers between subsequent layers or groups of layers, in the cross-sectional area of the inner skin structures, changes in the thickness of the outer skin structure, and/or changes in the length of each crash pad layer. Stiffness also may be varied by changes in the geometry of the outer skin structure and/or inner skin structure, or combinations thereof.

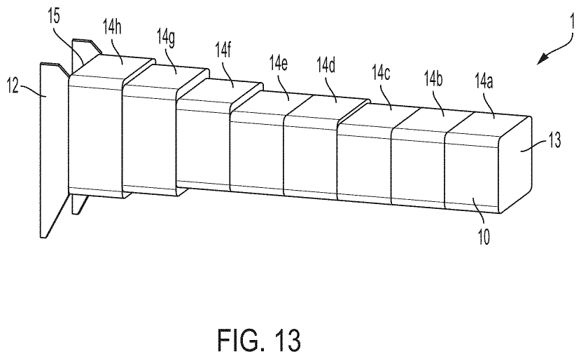

As shown in FIG. 13, the UDU may include one or more brackets 12, which may be used to attach the UDU to the appropriate vehicle structure. For example, the UDU may be attachable to a portion of the wheel well, the hinge pillar, A-pillar, A-pillar reinforcement, rocker, sill beam, or any other suitable vehicle structure). It should be appreciated that the brackets 12 may be attached to the appropriate vehicle structure with any suitable attachment mechanism, including, but not limited to, simple mechanical joining including crimping, screws or brackets, ordinary welding, friction stir welding, addition of high-strength adhesives, fasteners, or any combination thereof. In some embodiments, the brackets may each include substantially planar structures that extend away from the body of the UDU (e.g., the second end of the body).

FIGS. 14-17 illustrate arrangements of the inner and outer skin structures of exemplary crash pad layers of the UDUs. As shown in these views, the shape and size of the outer skin may vary from layer to layer. In some embodiments, the outer skin structure may be substantially rectangular in cross-sectional shape. In some embodiments, (see FIGS. 14, 15, and 17), the outer skin may have curved corners connecting planar segments. In other embodiments (see FIG. 16), the outer skin may include an octagonal cross-sectional shape, formed of only planar segments.

FIGS. 14-17 also illustrate the different shapes of the inner skin structures. For example, as shown in FIG. 15-16, the inner skin structures may include the same shape (e.g., be circular in cross-section), although the inner skin structures in each layer may vary in size, number, and placement. In some embodiments, inner skin structures may be positioned at or near each corner of the crash pad layer. As shown in FIG. 17, the inner skin structures may include different shapes. In such embodiments at least one inner skin may have a shape that differs from at least another inner skin.

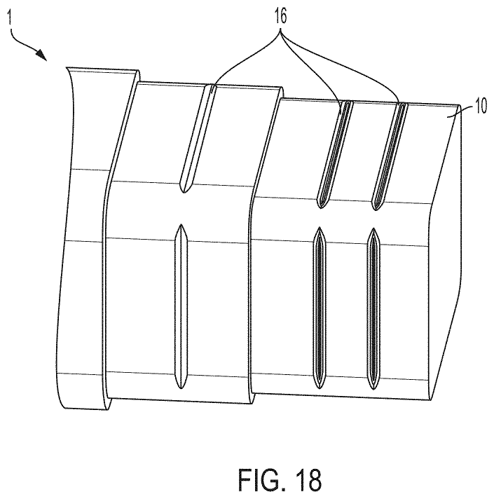

In some embodiments, the stiffness of an individual crash pad layer may be adjusted by introducing features to control the axial deformation of the crash pad layer. As shown in FIG. 18, in some embodiments, the outer skin structure may include one or more areas of weakness. For example, the outer skin structure may include slits, notches 16, or grooves. The notches 16 may be configured to allow the crash pad layer to collapse or buckle in either distinct locations (e.g. at the positions of the groove) and/or at a distinct absorbed load. In such embodiments, the buckling (e.g. failure) of the notches 16 may decrease the stiffness of the crash pad layer 14.

In some embodiments, the introduction of the notches 16 may control the sequence of load transfer between adjacent crash pad layers. In other words, a crash pad layer with notches and a lower stiffness than a neighboring crash pad layer, may buckle at a lower load when compared to a crash pad layer without notches. In this way, the neighboring crash pad layer (which may be stiffer) may absorb more of the load, and given its increased stiffness, may absorb more of the load more efficiently than the lower stiffness crash pad layer. It should be appreciated that the notches may be configured to allow the crash pad layer to buckle prior to plastic deformation of another feature of the crash pad layer (e.g., the outer wall structure or the inner skin structures).

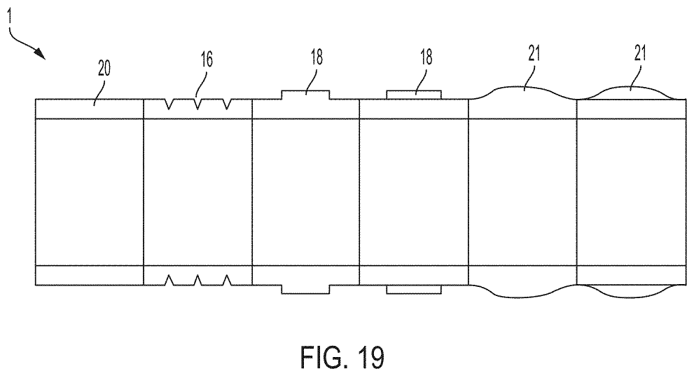

As shown in FIGS. 18 and 19, the notches 16 may be formed in an outer surface of the outer skin structure. In some embodiments, the notches may extend perpendicular to the length of the crash pad layer. In such embodiments, the notches 16 may buckle when absorbing sufficient axial load.

In some embodiments, the notches may be substantially equal and equidistant notches in a crash pad layer, although the notches may be positioned in other suitable manners along a crash pad layer and may have different sizes. As will be appreciated, the notches may be any suitable shape, size, and/or orientation. In an illustrative example, as shown in FIGS. 18 and 19, the notches may be substantially V-shaped. In some embodiments, the shape and size of the notches may be the same on each layer, although the shape and sizes may vary from notch to notch on the crash pad layer. The notches may be the same shape and size between crash pad layers, although the shape and size may be the same across the crash pad layers.

In some embodiments, crash pad layer may include notches 16 mirrored along the axial direction of the crash pad layer, such that collapse or buckling of the notches and a first side of the crash pad layer may result in the collapse or buckling of notches on the other side of the crash pad layer when the applied crash load is substantially symmetric. It should be appreciated that in some embodiments, for example when an uneven axial load is expected, the notches may be distributed unevenly or asymmetrically around and/or along the crash pad layer. In such embodiments, the asymmetric distribution of notches may provide asymmetric stiffness enhancement of the crash pad layer, which may be useful in instances of an asymmetric crash load.

FIG. 19 also illustrates stiffeners that may be incorporated to increase stiffness of one or more crash pad layers. In some embodiments, the crash pad layer may include stiffeners 18 that locally increase the cross-sectional area or thickness (or any other suitable geometric dimension) of the outer skin structure of the crash pad layer. In some embodiments, the stiffener may have a substantially rectangular cross-sectional shape (see stiffeners 18 in FIG. 19). In other embodiments, stiffener 21 may be semi hemispherical in cross-sectional shape. The stiffeners may have other suitable shapes in other embodiments (e.g., triangular in cross-sectional shape). Although described on the outer skin, it will be appreciated that local stiffeners also may be added to one or more inner skin structures.

As with the notches, the stiffeners may be located on any suitable portion of the outer skin and have any suitable shape and size. In some embodiments, the stiffeners 18 may span around the entire crash pad layer. For example, the stiffeners may be formed as an annular ring on the outer skin of the crash pad layer. In other embodiments, the stiffeners 18 may be discontinuous around the crash pad layer. For example, local stiffeners 18 may be located at precise positions around the crash pad layer, such as where a greater crash load may be expected. In some embodiments, the stiffeners 18 may extend outwardly from the outer surface of the outer skin structures. In some embodiments, each layer may have the same number of stiffeners, although the number (or shape of the stiffener) may vary from layer to layer. In some embodiments, a single crash pad layer may include more than one shape of stiffener. In other embodiments, the crash pad may have no stiffener (or notch). See, for example, the straight wall segment 20 in FIG. 19, with no stiffeners or notches. See also the UDU of FIG. 46, which shows layers with different stiffeners, and a layer with notches.

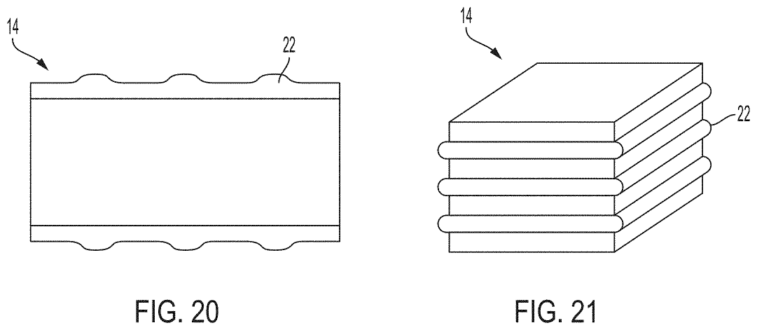

In some embodiments, the stiffeners 22 may form a pattern, such as a rippled pattern along an exterior of the outer skin of the crash pad layer. See, e.g., FIGS. 20 and 21. In one example, the rippled pattern may include troughs and peaks. As will be appreciated, the shape and pattern of the stiffeners may differ in other embodiments. For example, although the ripple stiffeners 22 are shown as being substantially semi-hemispherical in shape, in other embodiments, the ripple stiffeners 22 may be substantially square, triangular, other polygonal or other cross-sectional shape. Also, although the stiffener 22 is shown to extend around the entire crash pad layer, in some embodiments, stiffeners 22 may be located on only portions of the crash pad layer.

In some embodiments, the stiffeners may be integrally formed with the outer skin structure. In such embodiments, the stiffeners may be formed of the same material as the outer skin structure. In other embodiments, the stiffeners may be fixedly attached to the outer skin structure 10 (e.g., via adhesives, welding, fasteners, locks, press-fit or any other suitable mechanism). In some embodiments, the stiffeners may be formed of a different material than the outer skin structure. As will be appreciated in view of the above, the material, shape, position, orientation, or any other property of the stiffeners may be adjusted in order to tailor the stiffness and energy absorption properties of the crash pad layer.

In some embodiments, each layer of the multilayer UDU may behave like an individual crash pad. The UDU skin structures for each layer of the UDU may consist of one outer skin structure or it may include a combination of outer and inner skin structures. The inner structures may be oriented either parallel to the crush axis or normal to the crush axis. The determination of the shape, orientation, and position of the inner structures may depend on the required stiffness of a particular layer of the UDU.

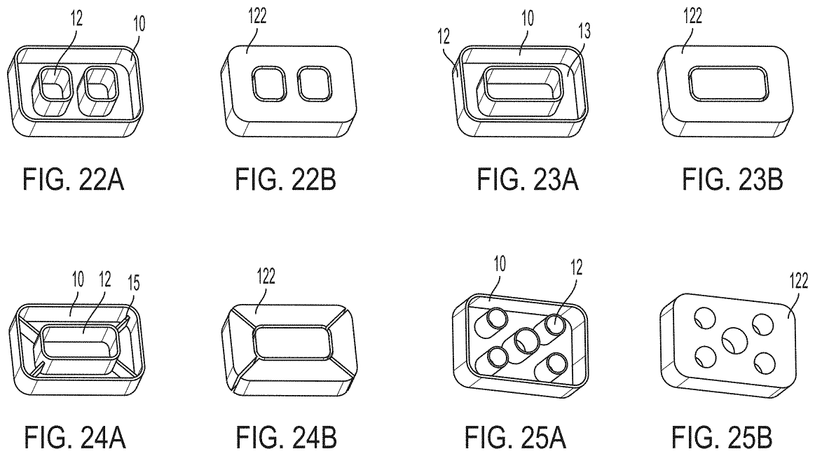

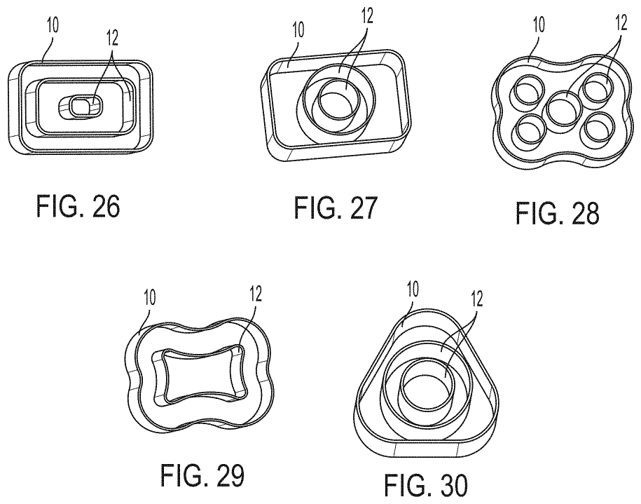

Exemplary embodiments of crash pad layers with both outer and inner skin structures are shown in FIGS. 22A-25A and 26-30. FIGS. 22B-25B show the foam 122 insertable into and around the inner skin structures of FIGS. 22A-25A, respectively. As shown in FIGS. 22A-25A and 26-27, the outer skin may be substantially rectangular in shape, with curved corners. The outer skin structure may have other suitable shapes, such as the triangular shape in FIG. 30 and the wavy or serpentine shapes in FIGS. 28 and 29. As shown in FIG. 26, for example, the inner and outer skin structures may be substantially the same shape, although different sizes. As shown in FIG. 30, the inner and outer skin structures may have different shapes and sizes. As shown in FIG. 23A and 25A, for example, at least one inner skin structure may be located in a central portion of the crash pad layer. The crash pad layers may have other suitable arrangements in other embodiments.

In some embodiments, the crash pad may also include a rib 15, which may connect the inner 12 and outer 10 skin structures together (see FIG. 24A). In some embodiments, the ribs may stabilize or otherwise strengthen the crash pad layer. The inner skin structure also may be connected to the outer skin structure via a web (e.g., a floor of the crash pad layer).

In some embodiments, the thickness of the outer skin structure and the inner skin structure may be substantially the same. In other embodiments, a thickness of the inner and outer skin structures may vary.

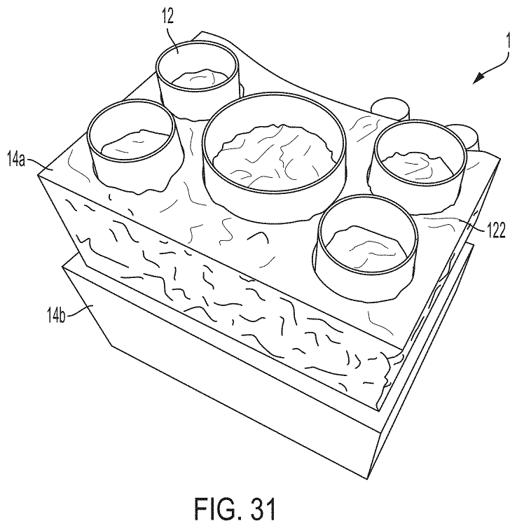

As shown in FIG. 31, for example, the space inside the inner skin structure and in between the inner and outer skin may be filled with a metallic foam 122, or another suitable energy absorbing material, such as another cellular material. In some embodiments, as shown in FIGS. 22B-25B, the metallic foam 122 may have a structure substantially similar to the negative (i.e. empty space) between the inner and outer skin structures. As will be appreciated, foam (or another suitable energy absorbing material) need not be positioned in each of the inner skin structures. In some embodiments, the foam may be positioned only in between the inner and outer skin structures. In other embodiments, the foam may be positioned only inside the inner skin structures.

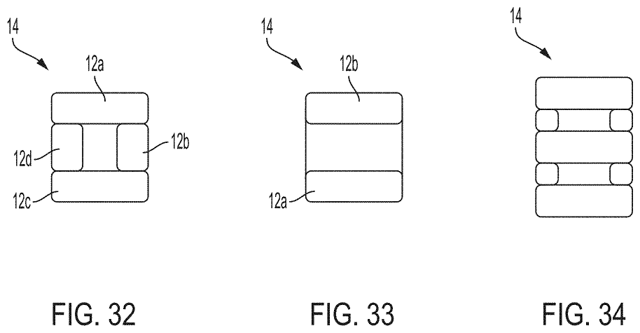

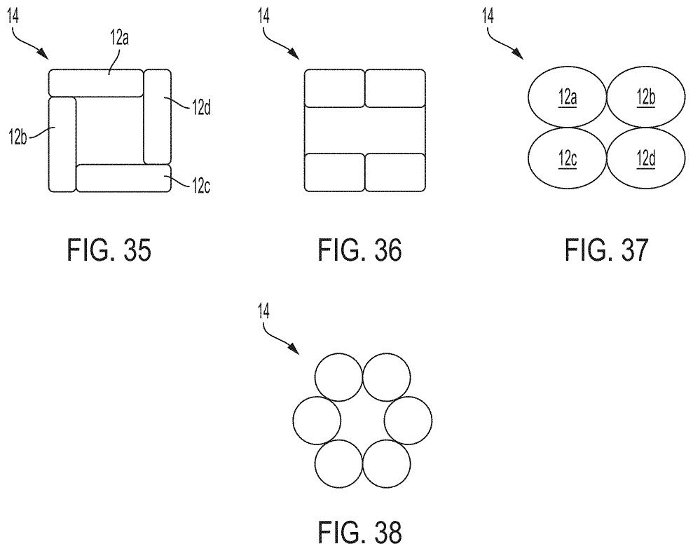

In some embodiments, instead of having an outer skin, the crash pad layers may be formed by joining one or more inner skin structures together. In this regard, the attached inner skin structures may form the outer skin of the crash pad layer. As shown in FIGS. 32-38, in some embodiments, the inner skin structures may be rectangular, square, circular, or oval in cross-sectional shape. In some embodiments, the inner skin members may be connected to form a substantially square, rectangular, round, or other suitable shaped crash pad layer. In some embodiments, the inner skin structures may be connected together to form the outer perimeter of the crash pad layer. As will be appreciated, the shape, size, and arrangement of the inner skin structures may be the same from layer to layer or may be varied from layer to layer. The inner skin structures may be joined together in any suitable manner.

In some embodiments, tubes (e.g., the circular cross-sectional structures) may be used as the inner tubular members (e.g., as inner skin structures) and used for axially crushing because they may buckle in under a predictable load (or stress or strain), when the thickness, diameter, and height are configured properly. In some embodiments, if the tube is too tall it may not buckle properly.

In some embodiments, the inner and outer skin structures of each layer may be an assembly of discrete structures, an assembly of subassemblies, or a monolithic structure. The various components of the assembly can be joined by a wide variety of methods including: welding, high strength adhesives, mechanical press-fit, swaging, and/or other mechanical joining methods. Any combinations of these methods may also be used to join the components of the layer. In some embodiments, the same techniques also may be used to join the individual crash pad layers together to form the body of the UDU.

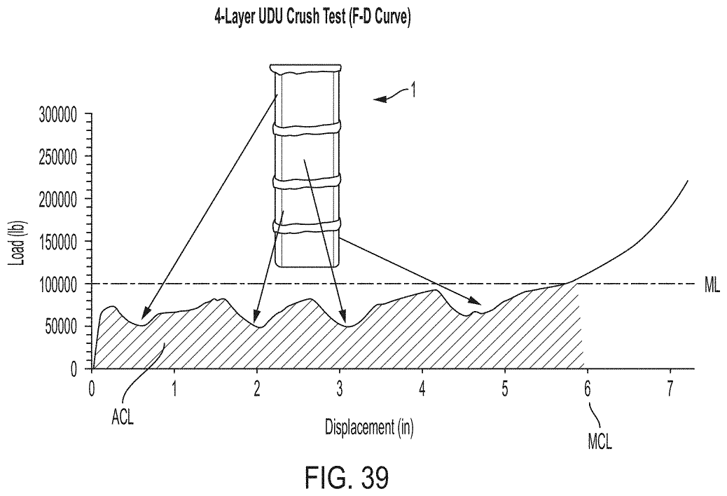

In some embodiments, in the segmented, multilayer UDU design, each layer may act as a crash pad to absorb a specific amount of crash energy. In such embodiments, since each layer is a unique structure, the layers may be designed in such a way as to create a sequential crushing during the crash event. This crushing action may be due to a predetermined amount of kinetic energy to be absorbed as strain energy as the UDU deforms. The amount of crash energy absorbed may equal to the area under the force vs. displacement (F-D) curve that results from the UDU crush. FIG. 39 is an example of a F-D curve, with the absorbed crash energy ACL shown under the curve. As will be appreciated, each sharp peak corresponds to a crushing of a discrete layer of the UDU. For example, the peak corresponds to where the layer (e.g., the crash pad layer) begins to crush. In some embodiments, the softest curve may represent the layer (e.g., crash pad layer) at or near the nose of the car. In some embodiments, the multilayer UDU may allow the F-D curve to be engineered layer by layer in order to optimize energy absorption and minimize crash forces. In some embodiments, the maximum crush length MCL may be reached at the maximum allowable load on the vehicle body ML, as shown in the dashed line.

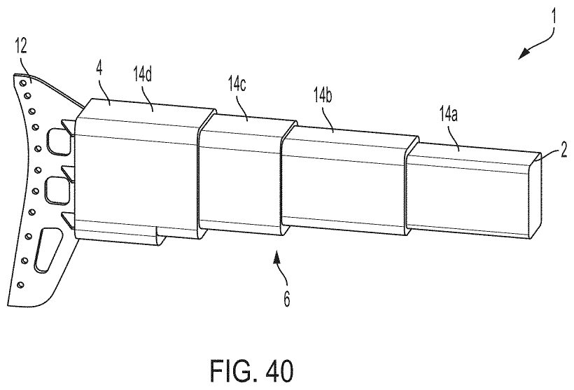

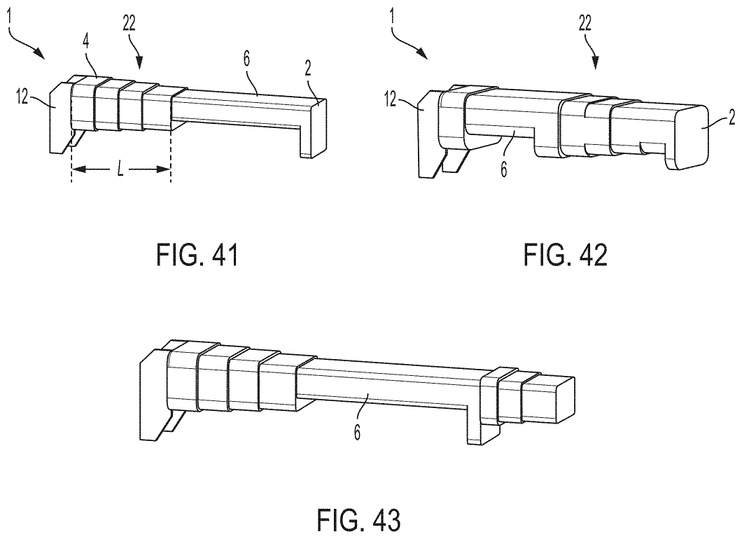

FIG. 40 is another embodiment of a multilayer UDU according to the present disclosure. As illustrated in this view, the crash pad layers of the UDU body may form forward and aft crash pads 2, 4 of the UDU. In this embodiment, each of the forward 2 and aft 4 crash pads may be formed of a single crash pads layer, with the connection beam 6 being formed of two crash pad layers. In some embodiments, the forward crash pad may be added and even extended to help capture the tire/wheel assembly during the crash (see FIGS. 41 and 42). In other embodiments, the forward crash pad may be shortened (see FIG. 40) to accommodate the package space behind the head lamp assembly. In some embodiments, as shown in FIGS. 41 and 43, the connection beam 6 may include a single crash pad layer that has been extended in the fore-aft direction (e.g., to extend over the wheel or at least a portion of the wheel of the automobile). In some embodiments, the aft crash pad 4 may be translated forward to create space for a connecting structure.

FIGS. 41-43 illustrate other arrangements of the multilayer UDU. In some embodiments, arrangements may be needed to connect the UDU to an existing vehicle structure or to adapt the multilayer UDU to certain vehicle architectures. Some arrangements may be useful for mass and/or cost reduction of vehicles (e.g., ones that do not require maximum SOL crash energy absorption.

In some embodiments, as shown in FIGS. 41 and 42, the UDU may include a primary energy absorption region 22. Such a region may include one or more layers, depending upon the required energy absorption (for example, five crash pad layers, as shown in FIG. 38). The primary energy absorption region 22 is shown as having a length L in FIG. 41. As shown in FIGS. 41 and 42, the UDU may include a connection beam 6. In some embodiments, the connection beam may include one or more layers (e.g., crash pad layers). Although a substantially rectilinear shape is shown for the connection beam 6, the connection beam also may have another suitable structure. Although a forward crash pad is shown, in some embodiments, the UDU may not include a forward crash pad. The forward crash pad may have shortened and/or extended arrangements.

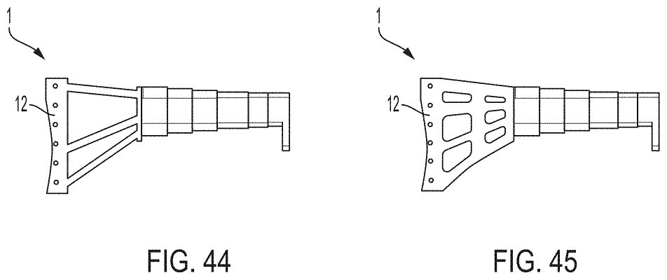

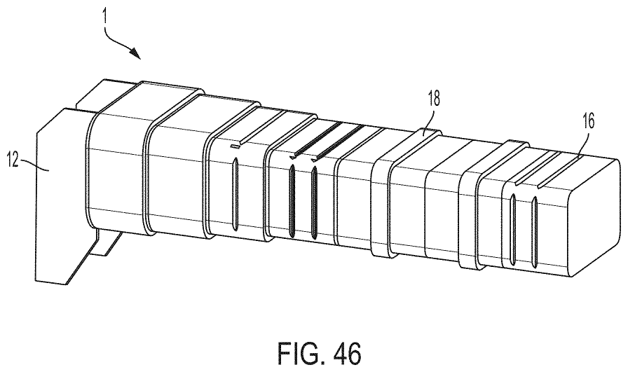

As shown in FIGS. 44 and 45, the UDU may include a bracket 12 arranged to attach the UDU in an automobile. As will be appreciated, the bracket may be arranged to correspond with one or more structures of the car to which the UDU is attached.

As described herein, the UDU may include any number of crash pad layers, where each crash pad layer may include an outer skin structure with a suitable shape, arrangement, or size, and a stiffener and/or notch with a suitable shape, arrangement or size. The crash pad layer also may include inner skin structures including a suitable shape, arrangement, or size. It should be appreciated that the UDU may include any combination of these features and properties, as shown in FIG. 46, for example. The features and properties may be uniquely designed for each layer to adjust or otherwise control the stiffness of each crash pad layer. In other words, according to embodiments herein, various features and properties may be used to control the crash behavior of each crash pad layer.

As will be appreciated by one skilled in the art, the individual components of a UDU may be fabricated from a wide variety of materials, using a wide variety of shaping methods, and joined into an assembly using a wide variety of generally available methods. Exemplary materials, though not limiting the scope of this disclosure, include alloys of aluminum known for having combination of high strength, low density, and relatively low cost; but also carbon fiber composites, polymer composites, metal matrix composites, layered composites including steel, and high-strength plastics. For example, crash pads may be constructed of a material having a mass per unit volume less than about 3,000 kg/m3; yield strength of at least 180 MPa; and Young's modulus of at least 500 MPa. Cellular materials having porosity substantially greater than zero may be of particular interest for combination of high strength and low density. For example, crash pads may be constructed of a cellular material having a mass per unit volume less than about 1,000 kg/m3. Exemplary shaping methods, though again not limiting the scope of the disclosure, include stamping, forging, casting, machining, and printing. Joining methods may include simple mechanical joining including crimping, screws or brackets, mechanical press-fit, ordinary welding, friction stir welding, addition of high-strength adhesives, fasteners, or any combination of the above. As will be appreciated, while each component of the UDU may be made of the same material and/or by the same manufacturing technique, the components also may be made of different materials and/or by different manufacturing techniques.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A safety device for absorbing crash energy, the safety device comprising:
a body having a first end, a second opposite end, and a plurality of stacked crash pad layers, wherein each of the plurality of crash pad layers includes an outer skin;
wherein a stiffness of the body increases in a direction from the first end of the body towards the second end of the body.

2. The safety device of claim 1, wherein the plurality of stacked crash pad layers includes first, second, and third crash pad layers.

3. The safety device of claim 2, wherein the first crash pad layer is located at the first end of the body and the second crash pad layer is located at the second end of the body.

4. The safety device of claim 3, wherein a stiffness of the first crash pad layer is less than a stiffness of a second end of the body.

5. The safety device of claim 4, wherein the first crash pad layer includes a first outer skin and the second crash pad layer includes a second outer skin, wherein a thickness of the first outer skin is less than a thickness of the second outer skin.

6. The safety device of claim 4, wherein a cross-sectional area of the second crash pad is greater than a cross-sectional area of the first crash pad.

7. The safety device of claim 2, wherein a length of the first crash pad is different than a length of the second crash pad.

8. The safety device of claim 4, wherein the first crash pad layer includes a first inner skin and the second crash pad layer includes a second inner skin, wherein a cross-sectional area of the first inner skin is less than a cross-sectional area of the second inner skin.

9. The safety device of claim 8, wherein each of the first and second inner skins includes a hollow tubular structure.

10. The safety device of claim 9, wherein the tubular structure includes a circular, square, triangular, oval, and/or rectangular cross-sectional shape.

11. The safety device of claim 2, wherein the first crash pad layer includes an inner skin.

12. The safety device of claim 11, wherein the first crash pad layer includes a cellular material disposed in the inner skin and/or between the inner skin and the outer skin.

13. The safety device of claim 12, wherein the cellular material includes a metallic foam.

14. The safety device of claim 1, wherein the stiffness of the body increases in a fore-aft direction when the safety device is installed in an automobile.

15. The safety device of claim 1, wherein the body includes a bracket arranged to attach the device to the automobile.

16. The safety device of claim 2, wherein the first crash pad layer includes one or more areas of weakness.

17. The safety device of claim 16, wherein the one or more areas of weakness include one or more notches and/or slits formed in the outer skin.

18. The safety device of claim 16, wherein the second crash pad layer includes one or more stiffeners extending outwardly from the outer skin structure of the second crash pad layer.

19. The safety device of claim 1, wherein the safety device includes first and second crash pads and a connection beam, wherein each of the first and second crash pads and the connection beam include one or more stacked crash pad layers.

20. A safety device for absorbing crash energy, the safety device comprising:
a body having a first end, a second opposite end, and a plurality of stacked crash pad layers, wherein each of the plurality of crash pad layers includes an outer skin;
wherein the plurality of crash pad layers includes a first crash pad layer and a second crash pad layer, wherein a thickness of the outer skin of the first crash pad layer is greater than a thickness of an outer skin of the second crash pad layer.

21. The safety device of claim 20, wherein a cross-sectional area of the first crash pad is the same as the cross-sectional area of the second crash pad layer.

22. The safety device of claim 20, wherein a cross-sectional area of the first crash pad layer is greater than a cross-sectional area of the second crash pad layer.

23. The safety device of claim 20, wherein the plurality of stacked crash pad layers includes a third crash pad layer positioned in between the first and second crash pad layers, wherein a thickness of the outer skin of the third crash pad layer is greater than the thickness of the outer skin of the second crash pad layer but less than the thickness of the outer skin first crash pad layer.

24. The safety device of claim 20, wherein the first crash pad layer includes one or more inner skins disposed inside the first outer skin and the second crash pad includes one or more inner skins disposed inside the second outer skin.

25. The safety device of claim 24, wherein the first crash pad layer includes a cellular material disposed inside the one or more inner skins and/or between the one or more inner skins and the outer skin.

26. The safety device of claim 20, wherein a thickness of the first crash pad layer is different than the thickness of the second crash pad layer.

27. The safety device of claim 20, wherein the safety device includes first and second. crash pads and a connection beam, wherein each of the first and second crash pads and the connection beam include one or more stacked crash pad layers.

28. The safety device of claim 20, wherein the outer skin of the first crash pad includes one or more areas of weakness and the outer skin of the second crash pad includes one or more stiffeners.

29. A safety device for absorbing crash energy, the safety device comprising:
a body having a first end, a second opposite end, and a plurality of stacked crash pad layers, wherein each of the plurality of crash pad layers includes an outer skin;
wherein the plurality of crash pad layers includes a first crash pad layer and a second crash pad layer, wherein the first crash pad layer includes a first inner skin and the second crash pad layer includes a second inner skin, wherein a cross-sectional area of the first inner skin is greater than the cross-sectional area of the second inner skin; and
wherein a stiffness of the first crash pad layer is different than a stiffness of the second crash pad layer.

30. The safety device of claim 29, wherein a thickness of the first inner skin is the same as a thickness of the second inner skin.

31. The safety device of claim 29, wherein a thickness of the first inner skin is different than a thickness of the second inner skin.

32. The safety device of claim 29, wherein each of the first and second inner skins includes a hollow tubular member.

33. The safety device of claim 32, wherein the hollow tubular member has a circular, square, rectangular, triangular, and/or oval cross-sectional shape.

34. The safety device of claim 29, wherein the first crash pad layer includes a third inner skin, wherein a cross-sectional area of the third inner skin is different than the cross-sectional area of the first inner skin.

35. The safety device of claim 29, wherein the first crash pad layer includes a third inner skin, wherein a cross-sectional area of the third inner skin is the same as that of the first inner skin structure.

36. The safety device of claim 35, wherein a thickness of the third inner skin is the same as a thickness of the first inner skin.

37. The safety device of claim 29, wherein the safety device includes first and second crash pads and a connection beam, wherein each of the first and second crash pads and the connection beam include one or more stacked crash pad layers.
